(19) United States
(12) Patent Application Publication
(10) Pub. No.: US 2020/0236163 A1
(43) Pub. Date: Jul. 23, 2020

(54) SCALE OUT NETWORK-ATTACHED STORAGE DEVICE DISCOVERY

(71) Applicant: ServiceNow, Inc., Santa Clara, CA (US)

(72) Inventors: Noam Biran, Tel Aviv (IL); Hail Tal, Kohav Yair (IL); Boris Erblat, Tel Aviv (IL); Tom Bar Oz, Herzliya (IL); Daniel Badyan, Tel Aviv (IL)

(21) Appl. No.: 16/252,073

(22) Filed: Jan. 18, 2019

(51) Int. Cl. H04L 29/08; H04L 12/24; H04L 29/06; G06F 9/455

(52) U.S. Cl. CPC H04L 67/1061; H04L 67/1097; H04L 41/0213; G06F 2009/45583; G06F 9/45558; G06F 2009/45595; H04L 63/10

(57) ABSTRACT

Systems, methods, and media are used to identify phishing attacks. A notification of a phishing attempt with a parameter associated with a recipient of the phishing attempt is received at a security management node. In response, an indication of the phishing attempt is presented in a phishing attempt search interface. The phishing attempt search interface may be used to search for additional recipients, identify which recipients have been successfully targeted, and provide a summary of the recipients. Using this information, appropriate security measures in response to the phishing attempt for the recipients may be performed.

### BACKGROUND

The present disclosure relates generally to discovery information about scale out network-attached devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Furthermore, the IT infrastructure solutions may be used to discover computing resources of the IT infrastructure and/or it connected devices. The computing resources (e.g., configuration items) hosted in distributed computing (e.g., cloud-computing) environments may be disparately located with each having its own functions, properties, and/or permissions increasing benefits of discovery. Such resources may include hardware resources (e.g. computing devices, switches, memory devices etc.) and software resources (e.g. database applications). These resources may be provided and provisioned by one or more different providers with different settings or values. Indeed, some of these different providers may control interfacing with scaling memory devices in a way that makes the devices difficult to discover due to interfaces with the scaling device and/or the properties of the scaling memory devices themselves.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Systems, methods, and media described herein are used to discover a scale-out network-accessible storage (NAS) device. This discovery process may be performed at least partially using automated routines, such as an application program, running on the network in question. When a configuration item (CI) is found by such routines, discovery includes exploring some or all of the CI's configuration, provisioning, and current status. This explored information is used to update one or more databases, such as the CMDB. The CMDB stores and tracks all of the discovered devices connected to the network.

However, as previously noted, some devices, such as scale-out network attached-storage devices may not be fully discoverable using discovery processes suitable for other CIs. For example, devices may be periodically and/or intermittently probed via discovery probes to determine information on devices connected to the network and return the probe results back to the requestor. Probes may have different types and functions. For example, some probes get the names of devices of specific operating systems (e.g., Windows or Linux) while other exploration probes return disk information for those devices using the operating systems. Some probes run a post-processing script to filter the data that is sent back to the requestor. However, these probes may not interact with some of the devices properly due to specific interactions (e.g., application programming interfaces (API)) not allowing such probing of all object storage nodes of a scale out storage architecture. Instead, the scale-out NAS may utilize a specific discovery process used to discover nodes of a cluster using a first API call. Discovery may then be run against each node individually with separate API calls. Similarly, each disk of the nodes may be discovered when running discovery against the nodes (or in a subsequent discovery process with an API call). For example, each disk may be separately and independently discovered using separate API calls after each node has been discovered.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a flow diagram of a process used to acquire information about nodes of a NAS device in the cloud architecture of FIG. 1, in accordance with aspects of the present disclosure;

FIG. 5 is a screen of a discovery interface used to run discovery against the NAS device, in accordance with aspects of the present disclosure;

FIG. 6 is a screen of the discovery interface when a parsing cluster information entry is selected in the discovery interface, in accordance with aspects of the present disclosure;

FIG. 7 is a screen of the discovery interface when a populate CMDB entry is selected in the discovery interface, in accordance with aspects of the present disclosure;

FIG. 8 is a screen of the discovery interface when a create relations entry is selected in the discovery interface, in accordance with aspects of the present disclosure;

FIG. 9 is a screen of the discovery interface when a get-disks-per-node entry is selected in the discovery interface, in accordance with aspects of the present disclosure;

FIG. 10 is a model of the NAS device that stores data obtained from the discovery process using the discovery interface, in accordance with aspects of the present disclosure;

FIG. 11 is a screen that may display a relational model showing relationships between elements of the NAS device, in accordance with aspects of the present disclosure; and

FIG. 12 is a flow diagram of a process used to implement a discovery process against the NAS device, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “configuration item” or “CI” refers to a record for any component (e.g., computer, device, piece of software, database table, script, webpage, piece of metadata, and so forth) in an enterprise network, for which relevant data, such as manufacturer, vendor, location, or similar data, is stored in a configuration management database (CMDB).

Given the wide variety of CIs associated with various devices within a computing system, configuration item (CI) discovery executed on a given infrastructure is used to track and/or map the CIs that are present on the connected IT environment. That is, CI discovery is the process of finding configuration items, such as hardware, software, documentation, location, and other information related to the devices connected to a given network, such as an enterprise's network. This discovery process may be performed at least partially using automated routines, e.g., an application program, running on the network in question. When a CI is found by such routines, discovery includes exploring some or all of the CI's configuration, provisioning, and current status. This explored information is used to update one or more databases, such as the CMDB.

The CMDB stores and tracks all of the discovered devices connected to the network. On computer systems, the discovery process may also identify software applications running on the discovered devices, and any connections, such as Transmission Control Protocol (TCP) connections between computer systems. Discovery may also be used to track all the relationships between computer systems, such as an application program running on one server that utilizes a database stored on another server. CI discovery may be performed at initial installation or instantiation of connections or new devices, and/or CI discovery may be scheduled to occur periodically to discover additions, removals, or changes to the IT devices being managed, thereby keeping data stored on the CMDB. Thus, using the discovery process, an up-to-date map of devices and their infrastructural relationships may be maintained.

However, as previously noted, some devices, such as scale out network attached-storage devices may not be fully discoverable using discovery processes suitable for other CIs. For example, devices may be periodically and/or intermittently probed via discovery probes to determine information on devices connected to the network and return the probe results back to the requestor. Probes may have different types and functions. For example, some probes get the names of devices of specific operating systems (e.g., Windows or Linux) while other exploration probes return disk information for those devices using the operating systems. Some probes run a post-processing script to filter the data that is sent back to the requestor. However, these probes may not interact with some of the devices properly due to specific interactions (e.g., application programming interfaces (API) not allowing such probing of all object storage nodes of a scale out storage architecture).

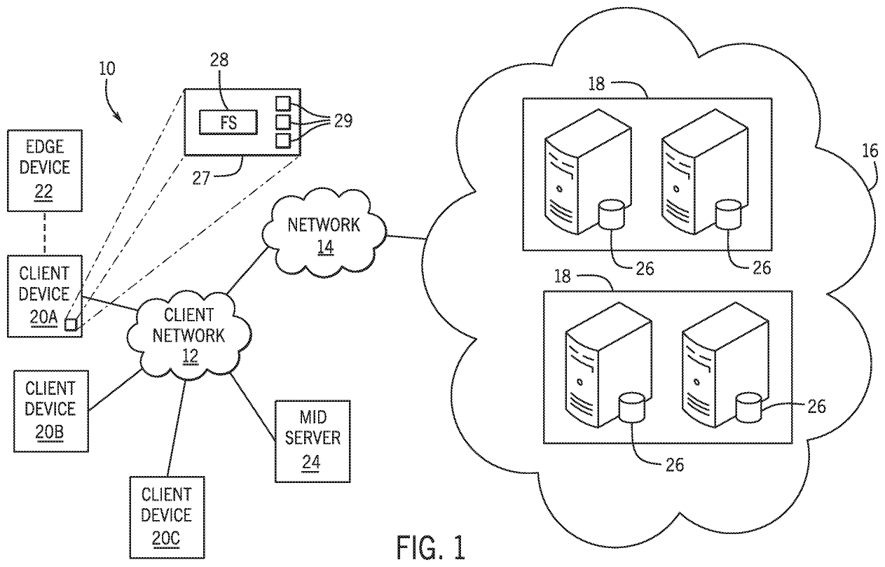

With the preceding in mind, the following figures relate to various types of generalized system architectures or configurations that may be employed to provide services to an organization in a networked or cloud-based framework (e.g., a multi-instance framework) and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, where embodiments of the present disclosure may operate, is illustrated. The computing system 10 may include a client network 12, a network 14 (e.g., the Internet), and a cloud-based platform 16.

In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. The client devices 20 may be used to display a discovery interface used to discover devices connected to one or more client networks 12.

FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. In some embodiments, the MID server 24 may act a discovery service and may be implemented using software on one or more of the client devices 20. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and/or execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

The client devices 20 may be and/or may include one or more configuration items 27 that may be discovered during a discovery process to discover the existence and/or properties of the configuration item(s) 27 in the client network 12 via the MID server 24. Configuration items 27 may include any hardware and/or software that may be utilized in the client network 12, the client network 14, and/or the platform 16. The configuration items 27 may include a scale out network-attached storage that provides high-volume storage, backup, and archiving of unstructured data using a cluster-based storage array based on industry standard hardware. The scale out network-attached storage may be scalable up to a maximum size (e.g., 50 petabytes) in a single file system using a file system 28. The file system 28 may be an operating system. For instance, the network-attached storage may include a EMC ISILON® device available from DELL EMC® that may utilize a OneFS® file system that is derived from a Berkeley Software Distribution (BSD) operating system.

The file system 28 may combine various other storage architectures, such as a file system, a volume manager, and data protection into a unified software layer creating a single intelligent distributed file system that runs on a storage cluster of the scale out network-attached storage. Indeed, the file system 28 may be a single file system with a single namespace. Data and metadata may be striped across the nodes for redundancy and availability with storage being completely virtualized for users and administrators. A file tree may grow organically without planning or oversight about how the tree grows or how users use it. Furthermore, the administrator need not plan for tiering of files to an appropriate disk because the file system 28 may handle tiering files without disrupting the tree. The file system 28 may also be used to replicate the tree without special consideration because the file system 28 may automatically parallelize the transfer of the file tree to one or more alternate clusters without regard to the shape or depth of the file tree. In some embodiments, the file system 28 may support both Linux/UNIX and Windows semantics natively, including support for hard links, delete-on-close, atomic rename, access control limits, extended attributes, and/or other features. The configuration item(s) 27 and its file system 28 may deploy node(s) 29 using hardware to implement the nodes as physical nodes or using software to implement the nodes. For instance, the configuration item(s) 27 and its file system 28 may deploy software nodes using software-defined storage, virtualization (e.g., VMWARE VSPHERE®). However, the file system 28 may restrict which actions are available on the nodes (e.g., using an API). The nodes 29 may have one or more disks used to store data in the NAS device.

Returning to FIG. 1, to utilize computing resources within the platform 16, network operators may choose to configure the data centers 18 using a variety of computing infrastructures. In one embodiment, one or more of the data centers 18 are configured using a multi-tenant cloud architecture, such that one of the instances of servers 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the instances of the server 26 causing outages for all customers allocated to the particular server instance.

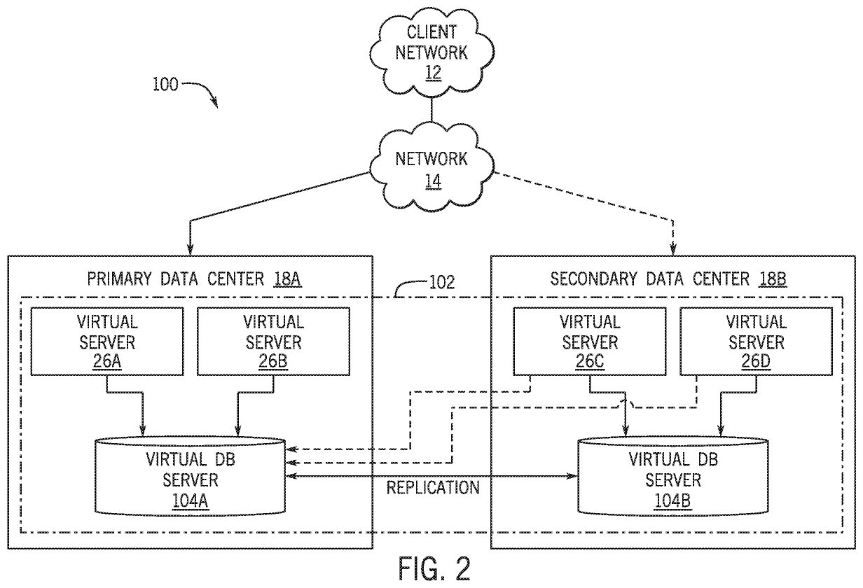

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers 26 (e.g., virtual servers 26A, 26B, 26C, and 26D) and dedicated database servers (e.g., virtual database servers 104A and 104B). Stated another way, the virtual servers 26A, 26B, 26C, 26D and virtual database servers 104A, 104B are not shared with other client instances but are specific to the respective client instance 102. Other embodiments of the multi-instance cloud architecture 100 could include other types of dedicated virtual servers, such as a web server. For example, the client instance 102 could be associated with (e.g., supported and enabled by) the dedicated virtual servers 26A, 26B, 26C, 26D, dedicated virtual database servers 104A, 104B, and additional dedicated virtual web servers (not shown in FIG. 2).

In the depicted example, to facilitate availability of the client instance 102, the virtual servers 26A, 26B, 26C, 26D and virtual database servers 104A, 104B are allocated to two different data centers 18A, 18B, where one of the data centers 18 acts as a backup data center 18. In reference to FIG. 2, data center 18A acts as a primary data center 18A that includes a primary pair of virtual servers 26A, 26B and the primary virtual database server 104A associated with the client instance 102, and data center 18B acts as a secondary data center 18B to back up the primary data center 18A for the client instance 102. To back up the primary data center 18A for the client instance 102, the secondary data center 18B includes a secondary pair of virtual servers 26C, 26D and a secondary virtual database server 104B. The primary virtual database server 104A is able to replicate data to the secondary virtual database server 104B (e.g., via the network 14).

As shown in FIG. 2, the primary virtual database server 104A may backup data to the secondary virtual database server 104B using a database replication operation. The replication of data between data could be implemented by performing full backups weekly and daily incremental backups in both data centers 18A, 18B. Having both a primary data center 18A and secondary data center 18B allows data traffic that typically travels to the primary data center 18A for the client instance 102 to be diverted to the second data center 18B during a failure and/or maintenance scenario. Using FIG. 2 as an example, if the virtual servers 26A, 26B and/or primary virtual database server 104A fails and/or is under maintenance, data traffic for client instances 102 can be diverted to the secondary virtual servers 26C, 26D and the secondary virtual database server instance 104B for processing.

Although FIGS. 1 and 2 illustrate specific embodiments of a computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

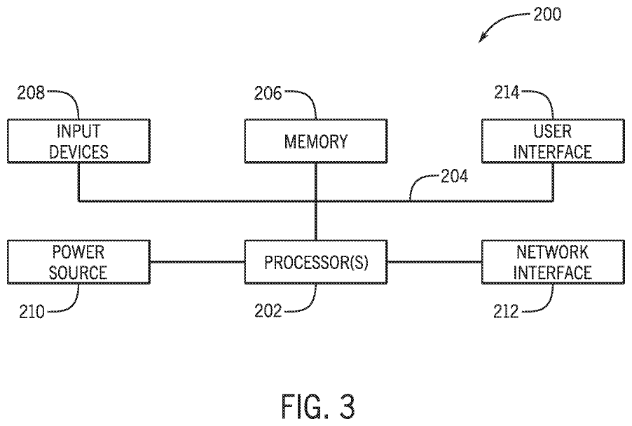

With this in mind, and by way of background, it may be appreciated that the present approach may be implemented using one or more processor-based systems such as shown in FIG. 3. Likewise, applications and/or databases utilized in the present approach stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

As previously discussed, the file system 28 may limit/control access to the nodes 29. For instance, the MID server 24 may interact with the file system 28 using one of any suitable protocols. For example, the file system 28 may support using a network file system (NFS) protocol, a Hadoop distributed file system (HDFS) protocol, a server message block (SMB) protocol, a hypertext transfer protocol (HTTP), a file transfer protocol (FTP), a representational state transfer (REST) protocol, and/or other suitable protocols for accessing, implementing, and/or managing file storage in the nodes 29. The MID server 24 may utilize one or more of such protocols to interact with the file system 28. For instance, the MID server 24 may send REST API requests via another protocol (e.g., HTTP). However, the file system 28 may not allow the MID server 24 to send a probe to acquire information about all of the nodes 29 with a single request.

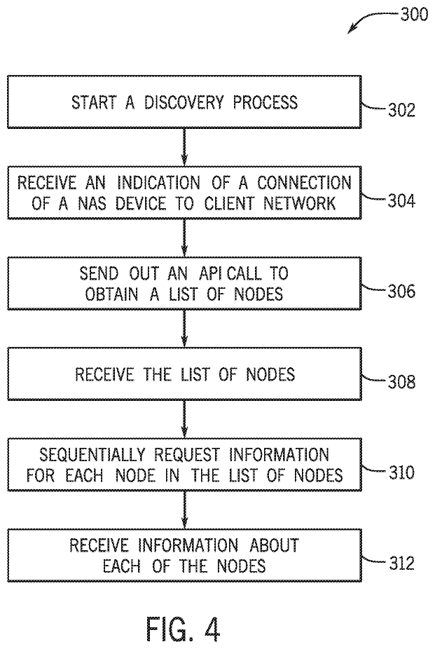

Instead, the MID server 24 may utilize a process 300 to acquire information about all of the nodes 29. FIG. 4 illustrates a flow diagram of the process 300. The process 300 includes the MID server 24 starting a discovery process based at least in part on a pattern that corresponds to a configuration item 27 including a scale-out network-attached storage (NAS) device (block 302). The MID server 24 receives an indication that the scale-out NAS device is connected to the system 10 (block 304). In some embodiments, this indication may be in response to a probe sent as part of a discover process. In the same discovery process and/or a later discovery process and/or during the discovery process used to determine connection of the scale-out NAS device to the system 10, the MID server 24 sends out an API call to obtain a list of nodes 29 for the scale-out NAS device (block 306). One or both discovery processes may utilize a pattern. The pattern may utilize a protocol (e.g., simple network management protocol (SNMP)) to identify the configuration item 27 as a specific type. For instance, the pattern may indicate an EMC ISILON® using an SNMP classifier of 1.3.6.1.4.1.12325.1.1.2.1.1 as an identifier used for SNMP queries to an EMC ISILON® device. As the request, the MID server 24 may use a REST API (e.g., Get Call operation) over HTTP to obtain the list of nodes of a memory cluster from the scale-out NAS device. In response to the API call, the MID server 24 may receive the list of the nodes 29 from the scale-out NAS device (block 308). For one or more of the nodes 29 indicated in the list, the MID server 24 may sequentially respond with requests for information about each of the one or more nodes 29 (block 310). For instance, the MID server 24 may sequentially request information about each of the nodes 29 in the list until information is acquired for each of the nodes 29 in the list. Additionally or alternatively, the MID server 24 may request information about each of the nodes 29 for which information has not been previously acquired and/or are indicated as having changed since a last discovery process stored in the CMDB. In response to the requests, the MID server 24 receives information about each of the one or more nodes (block 312). For instance, the information may include obtaining node disks for each node. Furthermore, obtaining node disks may include parsing and/or filtering information about the node disks. Additionally, the obtained information about the node disks may be displayed in a discovery interface.

In certain embodiments, each node may have discovery run against it. For instance, as part of obtaining attributes/information about the node, and the discovered disks may also be probed using individual API calls to each node discovering a list of disks and sending independent API calls to each disk to discover attributes about each disk. The attributes/information about the elements (e.g., cluster, nodes, and disks) may be stored in a configuration management database (CMDB). The information stored in the CMDB may be used to generate and/or display a model to graphically display the information. For instance, the model may include a relational model showing relationships/references between the various elements of the NAS device.

In some embodiments, interactions with the file system 28 may be secured. For instance, requests to the file system 28 may only respond to requests from the MID server 24 that include a SNMP Community string and/or password that may be used to indicate that a user initiating the discovery is authorized to access the scaled-out NAS device. In some embodiments, the SNMP Community string and/or password may be entered into a pattern by a user to initiate the discovery process acquiring information about the scale-out NAS device. Additionally or alternatively, the scale-out NAS device may be configured with permissions to enable the user to fetch information via the pattern. For instance, the following example privileges illustrate possible user privileges that may be set in the scale-out NAS device to enable discovery of the scale-out NAS device with proper identification indicating that the MID server 24 is authorized by an authorized user:
ID: ISI_PRIV_LOGIN_PAPI

Read Only: True
ID: ISI_PRIV_AUTH

Read Only: True
ID: ISI_PRIV_DEVICES

Read Only: True
ID: ISI_PRIV_NETWORK

Read Only: True
ID: ISI_PRIV_NFS

Read Only: True
ID: ISI_PRIV_SMARTPOOLS

Read Only: True
ID: ISI_PRIV_SMB

Read Only: True

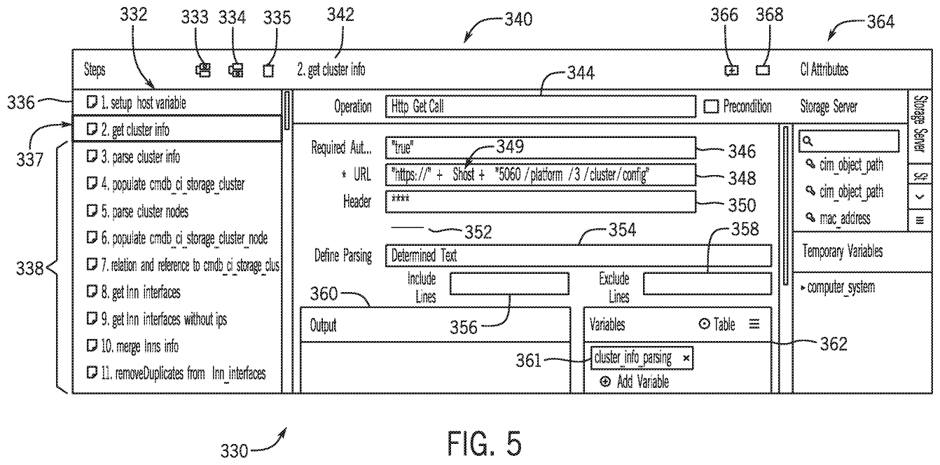

FIG. 5 is a screen 330 of a discovery interface. Particularly, the screen 330 includes a menu 332 of steps to be performed by the MID server 24 in discovering the configuration item(s) 27. The menu 332 may include steps that are visually indicated in a pattern and that may be used to complete the discovery process. The menu 332 may enable reorganization buttons 333 and/or 334 and a deletion button 335. The reorganization buttons 333 and/or 334 may be used to move items around in the menu 332. The deletion button 335 may be used to delete items in the menu 332. Each entry in the menu may correspond to one or more actions to be performed in the discovery process. For example, an entry 336 may be selected to setup a host variable indicating a location to be discovered that may be used by other steps in the discovery by using the set host variable.

An entry 337 of multiple entries 338 in the menu 332 may be selected to get cluster info for the scale-out NAS. Upon selection of the entry 337, a context-dependent window 340 may be display content based on which entry in the menu 332 is selected. When the entry 337 is selected, a title 342 corresponding to the entry 337 may be displayed. Furthermore, an operation box 344 may be presented to enable selection of the type of operation to be associated with the entry 337. For instance, to obtain the target of getting cluster info, the screen 330 includes an operations box 344 that may be used to select a dropdown item (e.g., HTTP Get Call) to perform a corresponding step of the discovery process. The screen 330 may also display, in the context-dependent window 340, a required authorization box 346 that may be used to select whether that interactions with the configuration item 27 utilizes an authorization in the discovery process. A uniform resource locator (URL) box 348 may be used to identify the location of the configuration item 27 or a component (e.g., a REST API call) thereof that is to be discovered using the pattern. As indicated, the URL box 348 includes a host variable 349 that may be set using the entry 336. For instance, the URL box 348 includes a string “‘https://”+$host+“:8080/platform/3/cluster/config’” that may be used to discover a cluster. Additionally or alternatively, calls to the configuration item 27 may utilize the following strings: ‘“https://”+$host+“:8080/platform/3/network/interfaces”’; ‘“https://”+$host+“:8080/platform/3/cluster/nodes”’; ‘“https://”+$host+“:8080/platform/3/zones”’; ‘“https://”+$host+“:8080/platform/3/network/pools”’; ‘“https://”+$host+“:8080/platform/3/storagepool/nodepools”’; ‘“https://”+$host+“:8080/platform/3/storagepool/storagepools”’; ‘“https://”+$host+“:8080/platform/3/nfs/exports”’; and ‘“https://”+$host+“:8080/platform/3/smb/shares”’ to gather corresponding information of corresponding components of the scale-out NAS device.

A header box 350 may be included to indicate headers that may be used in the discovery process. A run operation button 352 may be used to run the operation indicated in the operation box 344. For instance, the operation may be run as part of the overall discovery process as a discovery request using the pattern and/or only the operation indicated by the operation box 344 may be performed without performing a remainder of the discovery process.

Returned data as part of the discovery process may be parsed for storage in the CMDB. A parsing box 354 may be used to indicate how the data is parsed. For instance, the return data may have delimited text, metadata tags and values, and/or other suitable formats for saving and/or transporting data from the configuration item 27 to the MID server 24.

An include line box 356 may be used to define which lines of data are to be included for transport to and/or storage in the CMDB. An exclude line box 358 may be used to define which lines of data are to be excluded from transmission and/or storage in the CMDB.

The context-dependent window 340 includes an output window 360 that indicates an output of the discovery process using the pattern and/or an output of the operation corresponding to the operation box 344. Variables 361 used in the discovery process may be identified in a variables window 362. Available attributes (e.g., variables, properties) of the configuration item 27 may be displayed in an attributes window 364.

In some embodiments, an add button 366 may be used to add additional steps to the discovery process and/or add related entries 338 in the menu 332. A test button 368 may be used to run a discovery process using a pattern including all the steps indicated in the menu 332.

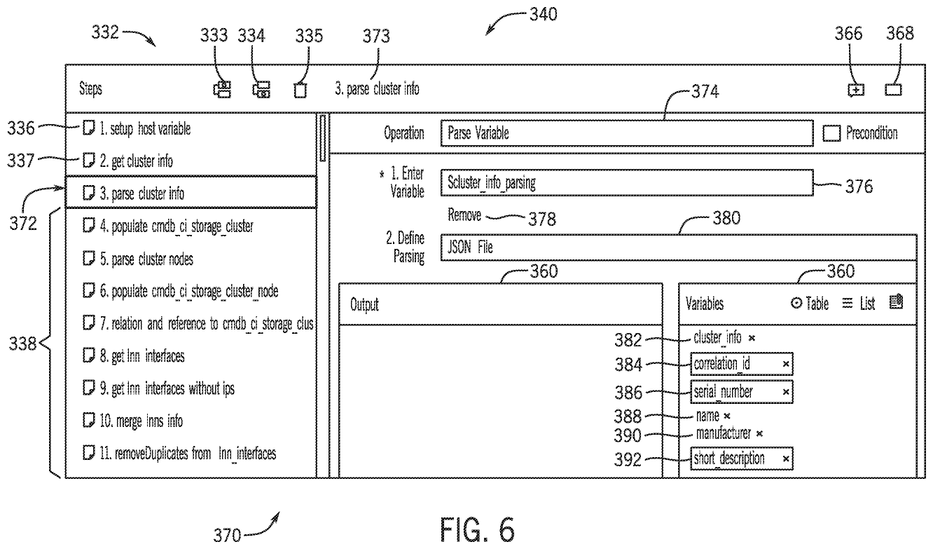

Once another entry 338 is selected in the menu 332, the context-dependent window 340 may display different information. For example, as illustrated in FIG. 6, a screen 370 may be displayed when an entry 372 is selected in the menu 332. In the screen 370, the context-dependent window 340 displays a title 373 indicating that the context-dependent window 340 is displaying content related to parsing cluster information. Specifically, an operation box 374 includes a parse variable operation that indicates that variables are to be parsed. A variable box 376 may be used to indicate the variable to be parsed. A retrieve button 378 may be used to retrieve the variable indicated in the variable box 376. The type of parsing applied to the variable indicated in the variable box 376 may be defined by a define parsing box 380.

The context-dependent window 340 includes the output window 360 that indicates an output of the discovery process using the pattern and/or an output of the operation corresponding to the operation box 374. Variables 382, 384, 386, 388, 390, and 392 used in the discovery process may be identified in a variables window 362. The variable 384, 386, 388, 390, and 392 may be sub-variables of the variable 382.

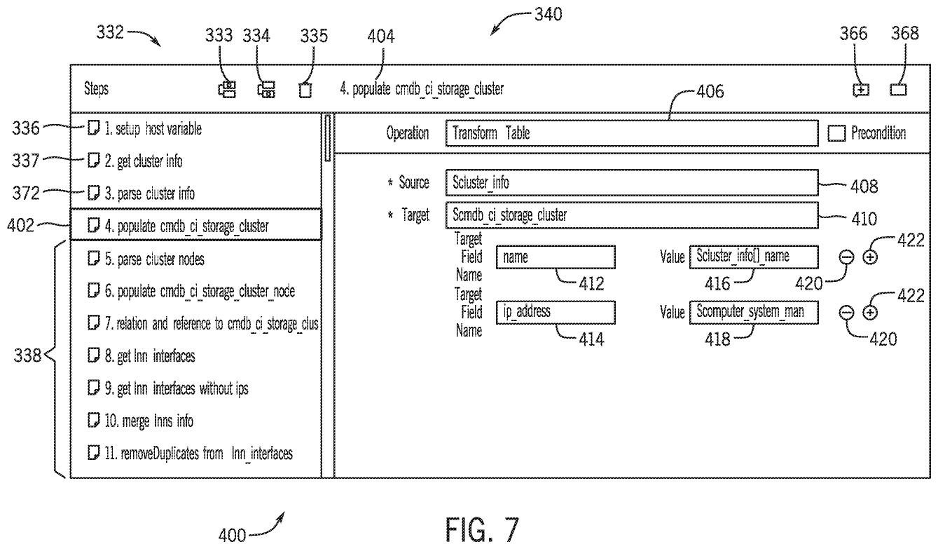

Once another entry 338 is selected in the menu 332, the context-dependent window 340 may display yet different information. For example, as illustrated in FIG. 7, a screen 400 may be displayed when an entry 402 is selected in the menu 332. In the screen 400, the context-dependent window 340 displays a title 404 indicating that the context-dependent window 340 is displaying content related to populating CMDB entries for the configuration item(s) 27. Specifically, an operation box 406 includes a parse variable operation that indicates that the incoming data is transformed into a table for the CMDB. A source box 408 may be used to identify from where the information is derived. A target box 410 may be used to identify a target of the CI. Target name fields 412 and 414 may be used to specify sub-fields of the CMDB entry, and value fields 416 and 418 may be used to specify values for the sub-fields. Deletion keys 420 may be used to delete sub-fields, and addition keys 422 may be used to add new sub-fields.

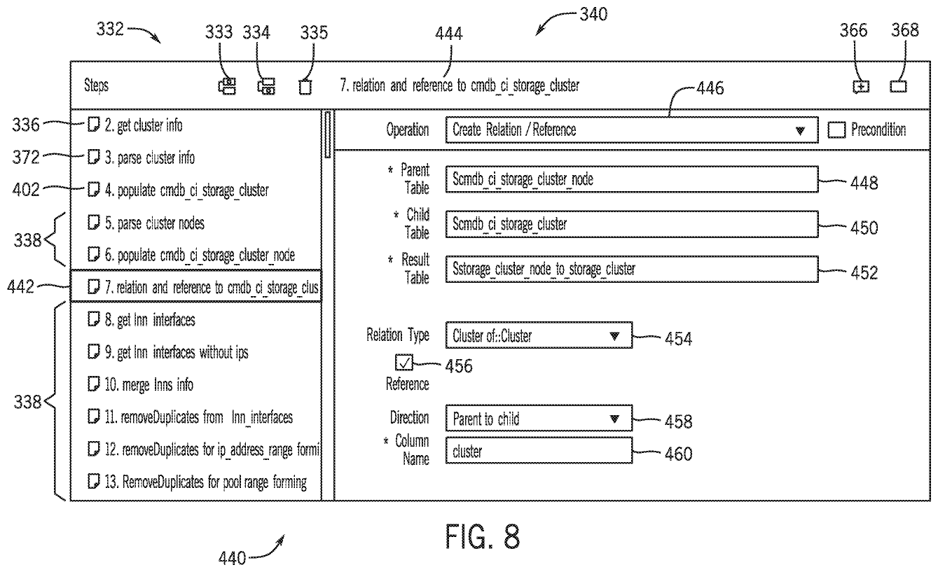

Once another entry 338 is selected in the menu 332, the context-dependent window 340 may display yet different information. For example, as illustrated in FIG. 8, a screen 440 may be displayed when an entry 442 is selected in the menu 332. In the screen 440, the context-dependent window 340 displays a title 444 indicating that the context-dependent window 340 is displaying content related to creating relations to CMDB entries for the configuration item(s) 27. Specifically, an operation box 446 includes a create relation/reference operation that indicates relations/references are to be created for entries in the CMDB. A parent table box 448 may be used to indicate a parent table (e.g., cluster node) of entries. A child table box 450 may be used to indicate a child table related to the parent table. A result table box 452 may be a table of results. A relation type box 454 may be used to indicate a relation type between the indicated tables. A selector 456 may be used to select whether the created item is a reference or a relation in the CMBD. A direction indicator 458 may be used to select a direction of the relationship (e.g., parent table to child table). A column name box 460 may be used to select a name of the column for the CMDB entry(ies).

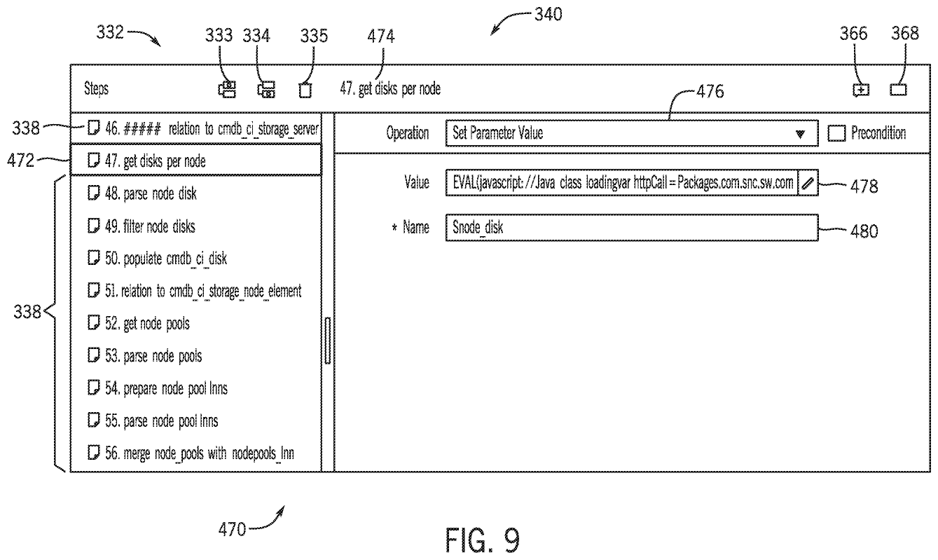

FIG. 9 is a get-disks-per-node screen 470 that may be displayed in response to a selection of a get-disks-per-node entry 472 in the menu 332. The context-dependent window 340 displays a title 474 that indicates that disks are to be obtained for each node. For instance, an operation box 476 may indicate that parameter values are to be set for the disks. A value box 478 may be used to call a program to get node information including the disks and iteratively obtain information for each disk indicated in the node information. A name box 480 may be used to identify a name for the parameter that is set.

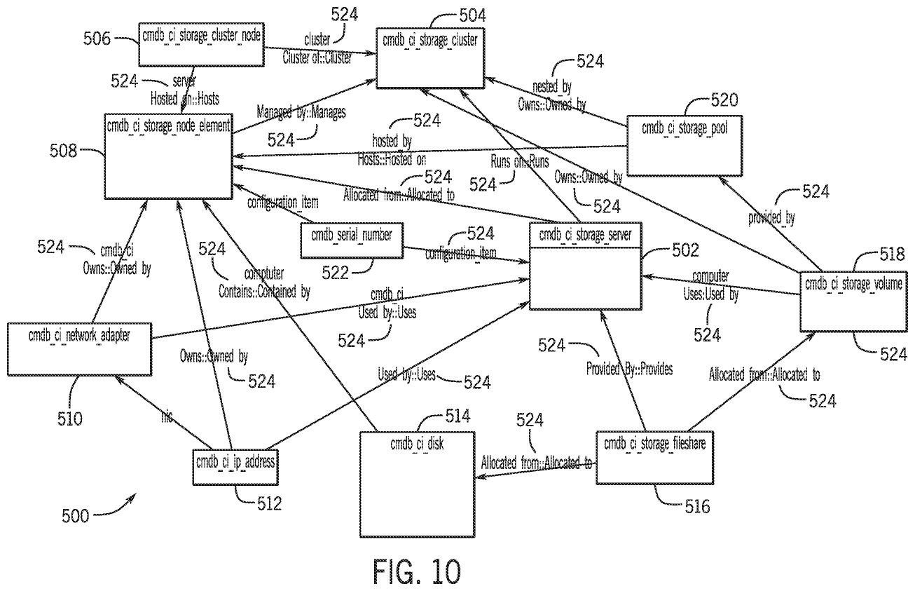

FIG. 10 is a model 500 of the configuration item 27 that stores the data that is obtained using the discovery process using the pattern. The model indicates a storage server element 502 that corresponds to a server hosting the scale-out NAS cluster. The storage server element 502 may have associated elements, such as a serial number of the scale-out NAS device, a firmware version of the of firmware installed on the scale-out NAS device, a name of the scale-out NAS device, a short description configured during installation of the scale-out NAS device, an IP address of the scale-out NAS device, a location (e.g., geographic location, room location, rack location, etc.) of the scale-out NAS device, a manufacturer of the scale-out NAS device, a model ID that is an identification string that identifies the model of the scale-out NAS device, and/or other suitable information about the scale-out NAS device.

The model 500 also includes a storage cluster element 504 that may store information about a storage cluster. For instance, the storage cluster element 504 may include a name, an IP address, a short description, a manufacturer, a serial number, and/or connection identifier of the cluster that scale-out NAS devices form.

The model 500 also includes a storage cluster node element 506. The storage cluster node includes a name and other attributes (e.g., operational status, cluster, server, etc.) of the node that is part of the scale-out NAS storage cluster. Moreover, the model 500 may also include a storage node element 508 that stores information about a physical nodes that are hosted by the storage cluster. The storage node element 508 may store information about a name, a manufacturer, a model ID, a short description, a serial number, an amount/type of memory, an amount/type of CPU cores, an IP address, and/or other information about the storage node.

A network adapter element 510 may be used to store information about a network adapter installed on the cluster node. For instance, the network adapter element 510 may show whether the network adapter is active, its IP address, its netmask, and/or other information about the network adapter. An IP address element 512 may store an IP address (and related attributes such IPv4 or IPv6) of the cluster node indicated in the storage cluster node element 506. Similarly, a CI disk element 514 may store information about a storage disk installed on the scale-out NAS device. For instance, the CI disk element 514 may store information about the disk similar to the other components of the model 500 with additional elements related to a number of bytes in the disk, an interface for the disk, and/or other memory-related parameters. A fileshare element 516 may store attributes of a fileshare server associated with the scale-out NAS device.

A storage volume element 518 may store attributes of a storage volume belonging to the storage cluster. For instance, the storage volume element 518 may include storage attributes, such total number of bytes, available number of bytes, and the like.

A storage pool element 520 may store attributes of a storage pool to which the storage cluster belongs while a serial number element 522 stores a serial number of the storage node.

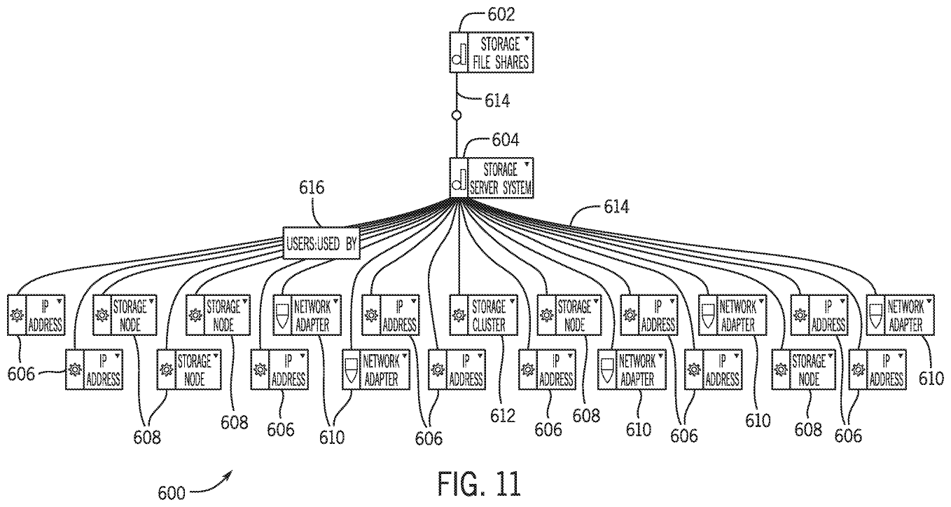

The model 500 also shows relationships/references 524 between the various elements of the model 500. Indeed, the discovery process may be used to understand dependencies in the computing system 10. Using the relationships/references 524, an alternative representation may be made of the elements of the model 500. For instance, FIG. 11 may show a relational model 600 showing a graphical depiction emphasizing relationships and dependencies between elements. As depicted, the relational model 600 includes a storage file shares element 602 that has a relationship with a storage server 604. The storage server 604, in turn, has relationships with IP address elements 606, storage node elements 608, network adapter elements 610, and storage cluster elements 612. The relational model 600 may also include a relation lines 614 indicating relationships between the various elements. Additionally or alternatively, the relational model 600 may include a legend 616 used to define or explain the significance of the relation lines 614 in the relational model 600.

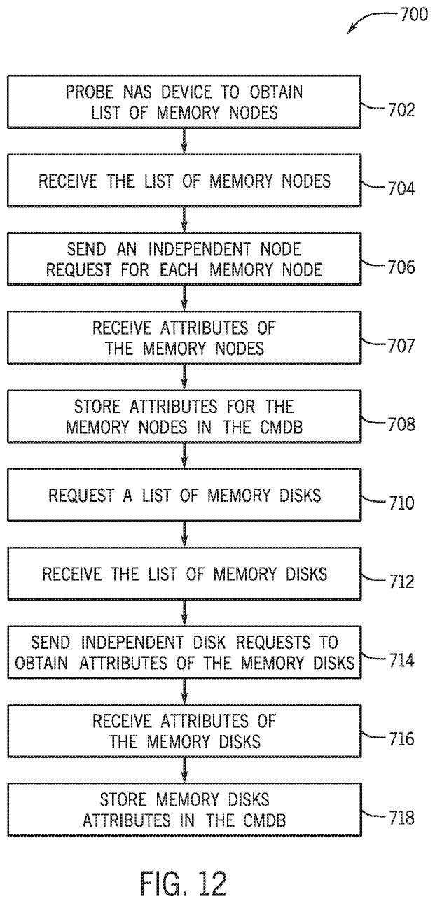

FIG. 12 is a flow chart diagram of a process 700 used to discover a scale-out NAS device as disclosed herein. The process 700 includes the MID server 24 in using an identifier to probe the NAS device to obtain a list of memory nodes of a memory cluster (block 702). For instance, the identifier may include an SNMP classifier. In some embodiments, the discovery using the MID server 24 may be in response to a request via a discovery interface and/or using a discovery schedule. The MID server 24 then receives the list of the memory nodes from the NAS device (block 704). For each memory node of the memory nodes, the MID server 24 sends an independent node request to obtain attributes of a respective memory node of the memory nodes (block 706). Also for each memory node and in response to the independent node request, the MID server 24 receives attributes of the respective memory node (block 707). The MID server 24 also stores attributes for each of the memory nodes in a configuration management database (block 708). For at least one of the memory nodes, the MID server 24 probes the NAS device to obtain a list of a memory disks of a memory node of the memory nodes (block 710). The MID server 24 also receives the list of the memory disks from the NAS device (block 712). In some embodiments, receiving information about the memory nodes may provide information about the memory disks of the node and may be foregone as a separate step in the process 700. For each memory disk, the MID server 24 sends an independent and separate disk request to obtain attributes of a respective memory disk of the memory disks (block 714). Also for each memory disk and in response to the independent disk requests, the MID server 24 receives attributes of the respective memory disks (block 716). The MID server 24 stores the attributes of the respective memory disks in the CMDB (block 718).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more client instances hosted by a platform, wherein the one or more client instances are accessible by one or more remote client networks, and wherein the system is configured to perform operations comprising:
receiving a request to perform a discovery process using a pattern; and
in response to receiving the request sending the discovery request to a discovery service hosted by the platform or the one or more remote client networks;
a configuration management database (CMDB) hosted by the platform, wherein the CMDB is configured to store information about configuration items of the one or more remote client networks; and
the discovery service hosted by the platform, wherein the discovery service is configured to perform operations comprising:
receiving the discovery request from the one or more client instances;
probing a scale-out network-attached storage (NAS) device to perform discovery against the NAS device with a request to obtain a list of memory nodes of a memory cluster;
receiving the list of memory nodes of the memory cluster;
for each memory node, iteratively probing a respective memory node of the memory cluster;
in response to probing each memory node, receiving attributes of the respective memory node; and
storing the attributes of each memory node in the CMDB.

2. The system of claim 1, wherein probing the NAS device comprises using a first application programming interface call type to obtain the list, and iteratively probing the memory nodes comprises using a second application programming interface call type with a separate call of the second application programming interface call type for each memory node to obtain attributes of the respective memory nodes.

3. The system of claim 1, wherein the discovery service is configured to request a list of memory disks for at least one memory node of the memory nodes.

4. The system of claim 3, wherein requesting the list of memory disks comprises using a third application programming interface call type.

5. The system of claim 3, wherein the discover service is configured to request information about each disk in the list of disks.

6. The system of claim 5, wherein requesting the list of memory disks comprises using a third application programming interface call type, and requesting information about each disk comprises using a third application programming interface call type with a separate call of the third application programming interface call type for each disk in the list of disks.

7. The system of claim 1, wherein receiving the request to perform the discovery process comprises receiving the pattern via a discovery interface of one or more client instances.

8. The system of claim 7, wherein the pattern specifies authorization to access the NAS device.

9. The system of claim 8, wherein the authorization comprises a simple network management protocol community string.

10. The system of claim 7, wherein the pattern comprises a simple network management protocol classifier to classify the NAS device.

11. The system of claim 10, wherein the simple network management protocol classifier comprises 1.3.6.1.4.1.12325.1.1.2.1.1.

12. The system of claim 1, wherein the one or more client instances are configured to display a model corresponding to the NAS device using the attributes stored in the CMDB.

13. A method for performing discovery against a scale-out network-attached storage (NAS) device comprising:
using an identifier, probing the NAS device to obtain a list of a plurality of memory nodes of a memory cluster;
receiving the list of the plurality of memory nodes from the NAS device;
for each memory node of the plurality of memory nodes:
sending an independent node request to obtain attributes of a respective memory node of the plurality of memory nodes; and
in response to the independent node request, receiving attributes of the respective memory node; and
storing attributes for each of the plurality of memory nodes in a configuration management database.

14. The method of claim 13, wherein probing the NAS device to obtain the list comprises an application programming interface call to the NAS device.

15. The method of claim 13, wherein each independent node request comprises an application programming interface call to the NAS device.

16. The method of claim 13, comprising displaying a model via a client instance of a configuration item corresponding to the attributes stored in the CMDB for the NAS device.

17. The method of claim 16, wherein the model comprises a relational model illustrating relationships between components of the NAS device.

18. The method of claim 13, comprising:
probing the NAS device to obtain a list of a plurality of memory disks of a memory node of the plurality of memory nodes;
receiving the list of the plurality of memory disks from the NAS device; and
for each memory disk of the plurality of memory disks:
sending an independent disk request to obtain attributes of a respective memory disk of the plurality of memory disks; and
in response to the independent disk requests, receiving attributes of the respective memory disks.

19. Tangible, non-transitory, and computer-readable medium storing instructions that, when executed, are configured to cause one or more processors to:
probe, using an application programming interface call of a first type, a scale-out network-attached storage (NAS) device to obtain a list of a plurality of memory nodes of a memory cluster;
receive the list of the plurality of memory nodes from the NAS device;
for each memory node of the plurality of memory nodes:
send an independent node request to obtain attributes of a respective memory node of the plurality of memory nodes, wherein each independent node request comprises an application programming interface call of a second type; and
in response to the independent node requests, receiving attributes of the respective memory node; and
storing attributes for each of the plurality of memory nodes in a configuration management database.

20. Tangible, non-transitory, and computer-readable medium of claim 19, wherein the instructions are configured to cause the one or more processors to:
probe the NAS device to obtain a list of a plurality of memory disks of a memory node of the plurality of memory nodes using an application programming interface call of a third type;
receive the list of the plurality of memory disks from the NAS device; and
for each memory disk of the plurality of memory disks:
send an independent disk request to obtain attributes of a respective memory disk of the plurality of memory disks, wherein each independent disk request comprises an application programming interface call of a fourth type; and; and
in response to the independent disk requests, receive attributes of the respective memory disks.
